(19) United States
(12) Patent Application Publication
(10) Pub. No.: US 2002/0066418 A1
(43) Pub. Date: Jun. 6, 2002

(54) Combination visual and electronic animal identification tag

(76) Inventors: D. Michael Fearing, Hastings, MN (US); George N. Johnson, Lake Elmo, MN (US)

Correspondence Address: SHERIDAN ROSS PC, 1560 BROADWAY, SUITE 1200, DENVER, CO, 80202

(21) Appl. No.: 10/008,450

(22) Filed: Nov. 30, 2001

Related U.S. Application Data
(60) Provisional application No. 60/251,472, filed on Dec. 5, 2000.

(51) Int. Cl. A62B 35/00

(52) U.S. Cl. 119/859

(57) ABSTRACT

A combination visual and electronic animal identification tag is provided. The tag includes at least two separate but matching identification means or identifiers which ensures that integrity of the identification is maintained. The electronic identifier is preferably in the form of an electronic transponder which emits a unique identifying signal corresponding to the particular animal. The visual identification means or identifiers may include a bar code, a visual management number, a feed lot number, an electronic identification number and others. Each of these additional forms of identification also match the electronic identifier. The multiple and redundant identifiers provides greater identification system reliability, and further provides users additional options in creating, storing, and manipulating information for a particular tagged animal.

### CROSS-REFERENCE TO RELATED APPLICATIONS

Priority is claimed from U.S. Provisional Patent Application No. 60/251,472, filed on Dec. 5, 2000 and further identified as Attorney Docket No. 2927-43-PROV, the disclosure of which is incorporated herein by reference in its entirety.

### FIELD OF THE INVENTION

The invention relates to animal identification tags, and more particularly, to combination electronic and visual identification tags having multiple identifiers for identifying the animal, therefore providing multiple ways in which to ensure proper identification and to enhance data which may be recorded concerning the animal.

### BACKGROUND OF THE INVENTION

Animal identification tags are a well-known means for providing essential management and tracking of both domestic and wild animals. A wide array of tags are available for use, and may take many different structural forms. Traditionally, visual tags were used containing a visual marking which identified the animal. Electronic identification tags have become popular in the industry, and in many instances have replaced visual tags. One popular form of electronic tags includes passive integrated transponder (PIT) tags which may be imbedded within the tissue of the animal, or may be attached externally to the animal. These commonly known PIT tag systems generally comprise one or more antenna coils so positioned as to generate a field of radiated electromagnetic energy within which the tagged animal must pass. As the PIT tag traverses the radiated field of electromagnetic energy, the tag is energized so that a unique identification signal is emitted by the tag, the signal corresponding to a unique identifier which specifically identifies the tagged animal. Typically, the PIT tag includes a wire coil which when passed through the electromagnetic field produces a current for powering a transmission circuit which emits the unique signal. The signal is detected by a reader which either transmits the signal to remote processing equipment which decodes the detected signal and uses this decoded information for purposes of counting, tracking or otherwise managing animal records or it decodes the signal itself.

Another type of recently popular animal identification tag includes those which are bar coded. As understood by those skilled in the art, the externally affixed bar code is passed over a scanner which reads the bar code, the bar code corresponding to a unique identifier which identifies a particular animal.

While bar code tags and electronic tags have certain advantages, there are also numerous drawbacks. For example, with bar code tags, the bar code readers must use line of sight identification of the tag. Therefore, any material which may cover the bar code or permit visualization of the bar code, such as dirt adhering to the bar code or the printed bar code wearing off, prevents reading of the tag. For both bar code tags and electronic tags, the animal must be brought in proximity to a reader. This requires movement of the animal to a location which may be some distance from the animal or portable readers brought to the location of the animal. For electronic tags, the tag must not only be brought in proximity to a reader, but it must be oriented relative to the reader's electromagnetic field to be successfully interrogated and decoded. Accordingly, there is a need for not only a reliable animal identification tag or system, but one which provides certain redundancy so that there can be quick, accurate and reliable identification of the animal. It is also desirable to provide this identification system within a single tag, thus preventing use of multiple tags which can result in improper matching of the tags, and inherently involves additional work in cross-referencing and matching the tags to properly identify the animal. Additionally, it would be greatly advantageous to provide an identification tag which not only includes multiple identifiers, but also links these multiple identifiers within a database which can accommodate a vast amount of information about the animal and that can be updated without re-tagging the animal.

### SUMMARY OF THE INVENTION

The combination visual and electronic animal identification tag of the present invention generally comprises an electronic means for identifying an animal, and at least one other matching identification means integrated within the same tag. The second identification means may include a bar code label and/or visual indicia to include one or more identifying number or letter sequences. The electronic identifier or identifying means is attached to an upper portion of a panel of the ear tag, while the second identifier or identification means is placed below the first identification means on remaining available panel space. The first identification means placed at the top of the panel allows ample room for one or more additional identifiers. Prior to distribution of the identification tag for use or sale, the two or more identifiers on each tag are linked via a database which denotes identifiers as matching records within specified fields of the database. The database can be loaded into operating software which reads the database, recognizes the matching records, and therefore allows the user to verify, update, or otherwise manipulate information within the database reflective of information entered about the particular tagged animal.

In one aspect, the invention can be conceptualized as an improved method of identifying an animal, including redundant identifiers incorporated within a single tag or device. In another aspect, the invention is an improved identification tag which locates an electronic identification means near the upper portion of the panel, thus leaving ample space for additional identifiers. In another aspect, the invention includes an animal identification system including not only the identification tag, but also a database stored on a storage disk which matches the various identifiers used on a single tag, and operating software which can read the data and allow database manipulation.

Additional advantages of the invention will become apparent from a review of the following drawings, taken in conjunction with the detailed description.

### BRIEF DESCRIPTION OF THE DRAWINGS

FIG. 1 is perspective view of the animal identification tag of the invention;

FIG. 2 is an exploded perspective view illustrating an electronic transponder contained in one element, and a male stud retaining member incorporated in another element, both shown as separated from a panel of the tag; and

FIG. 3 is a front view of the tag and further illustrates the manner in which different pieces of information or identifiers on the tag correspond to matching fields or entries in database for providing redundancy in animal identification, as well as generally enhancing data available about a particular tagged animal.

### DETAILED DESCRIPTION OF THE INVENTION

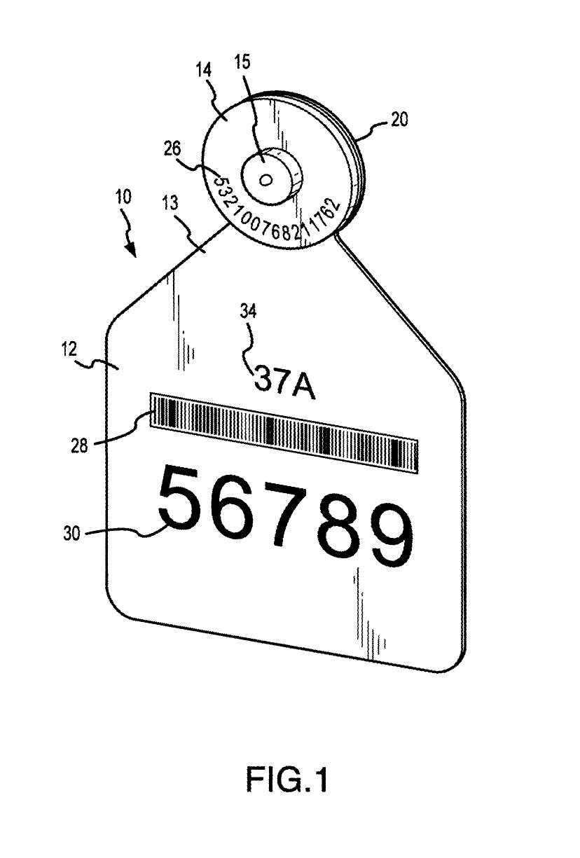

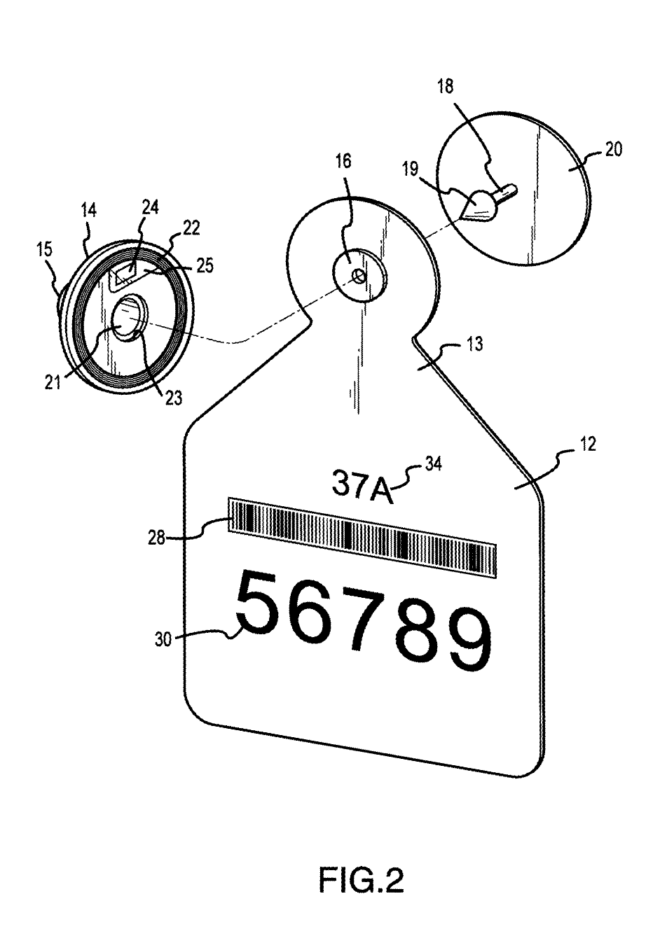

FIGS. 1 and 2 illustrate the identification tag 10 of the invention. The tag 10 includes a panel 12, and a transponder casing 14 attached to the upper portion or neck 13 of the panel. A male stud 18 is inserted through an opening 16 in the panel and an opening formed in the transponder casing 14 to secure the tag to an animal. The male stud 18 has a radially projecting retainer member 20 which retains or captures the ear between retainer member 20 and the neck portion 13 of the panel. The transponder casing or housing 14 includes a closed dome portion 15 which houses the arrow portion 19 of the stud 18. Thus, the arrow portion 19 does not protrude from the transponder casing 14. However, it should also be understood that the dome portion 15 may be removed, thus the arrow portion would be exposed. The advantage of the dome 15 is that it helps to prevent the arrow portion 19 from being caught in brush, barbed wire, or other potential obstacles which could damage or sever the arrow portion 19 causing the tag 10 to disengage the animal.

FIG. 2 specifically illustrates the components of the tag, to include the basic components making up the electronic identification means. The arrow portion 19 resides in a central opening 21 formed in the transponder casing 14. An internal flange 23 may be formed around the periphery of the opening 21 to capture and hold the arrow portion 19. Thus, the arrow portion 19 may slightly deform in response to force pushing it through opening 21. The transponder casing 14 houses a coil 22 which electrically connects with microchip 24, placed within an opening 25 formed in the casing 14. In order to stabilize the microchip 24 within the opening 25, a resin or other material fills the opening 25 to encapsulate the microchip 24 within the opening. The coil 22 powers the microchip when placed in the interrogation field, the microchip then emitting a signal which is unique to the particular tag. Typically, the signal matches a serial number assigned for the particular microchip. For each of the visual identifiers placed on the tag, these identifiers may be placed on the panel by various known means to include stamping, embossing, laser etching, or printing.

The transponder casing 14 may have the electronic identification number 26 placed thereon. This electronic identification number corresponds to the electronic signal emitted by the microchip 24. On the remaining panel portion, at least three other identifiers may be provided. A bar code 28 may be placed centrally on the panel, a visual identification number such as a management number 30 may be placed below the bar code 28, and yet another number 34 such as a feed lot number may be placed above the bar code 28. The bar code 28 may match the serial number for the microchip, and could also therefore match the electronic identification number 26. Although a specific location is shown for these other identifiers, it shall be understood that they may be arranged as desired on the portion on the panel below the transponder casing 14.

Although a specific construction is illustrated for the stud 18 and the transponder casing 14 which receives the arrow portion 19, it should be understood that the invention disclosed herein is not specifically limited to such an arrangement. For example, the opening 16 may be sized to receive and secure the arrow portion 19, and the transponder casing can be placed directly below this opening, still leaving ample room on the panel for placement of other identifiers. Alternatively, the neck portion of the panel could have an integral male stud protruding therefrom, and a female receptor element could then be used to secure the tag to the animal. In this alternate form, the transponder casing 14 would simply be placed directly below the male stud, and on an opposite side of the panel. Those skilled in the art can envision other arrangements which still accommodate the attachment of the transponder casing 14 to a neck portion of the panel, yet leaving ample room on the remaining portion of the panel to receive other identifiers.

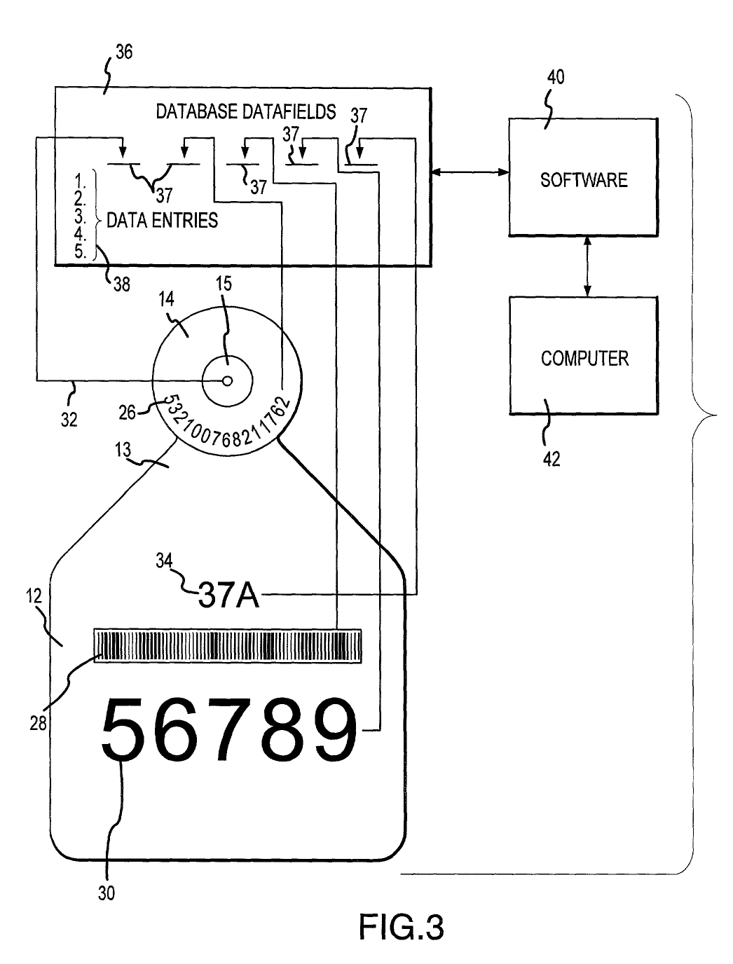

Now referring to FIG. 3, the interface between a database 36, and the various identifiers is shown. The database 36 may be recorded on conventional means to include a data disk or other forms of electronic data storage. The electronic signal identifier emitted by the transponder 24 is shown graphically as line 32, the electronic signal identifier corresponding to a particular field 37 within the database. Each of the other identifiers are also shown as matching a particular field 37 within the database. FIG. 3 illustrates the various identifiers corresponding to matching fields 37 that are separated horizontally in columns within the database. This representation of the identifiers in this manner within the database 36 is intended to simply show that each of the identifiers can be used to identify a particular animal, and selected data entered about the animal within the database. Also within the database, multiple data entries 38 are found which contain the actual data for the animal. These data entries are graphically depicted as rows within the database. Thus, the various identifiers provide desired redundancy in ensuring that a particular animal is properly identified. Additionally, each of the identifiers may correspond to a particular type of data in a corresponding field 37 for the particular animal. The database 36 can be manipulated by operating software 40 to add, delete, or otherwise edit the data. Examples of commercially available software which manages animal data include Aginfolink™, Emerge™, or Elextron™. This software 40 is loaded into a conventional computing device 42 having a microprocessor and memory.

By a review of FIGS. 1 and 2, it is seen that the transponder casing 14 is located on the panel such that the major remaining portion of the panel is open to receive various identifiers. Accordingly, the size of the identification tag is maintained in a desirable compact size, thus eliminating the need for multiple tags, or increasing the size of the tag.

Because of the redundant identification means provided by the tag of the invention, identification of an animal is simpler, and more effective. Even if a particular identification system fails, for example, if the bar code label cannot be read by failure of a bar code reader, or a general failure of a bar coding system, the electronic tagging means is still available for identifying the animal. Even if the electronic tagging system fails for some reason, the visual or management number is still available to identify the animal, as well as the electronic identification number on the transponder casing. Because the visual number is already cross-referenced and matched with the various other identifiers, positive animal identification is achieved. Particularly in feed lot operations, feed lot operators often use their own feed lot numbers to identify an animal. By providing space on the panel for a feed lot number, there is no need to place an additional tag on the animal, and potential confusion by mismatching an additional tag is eliminated. Additionally, providing a single tag with redundant identification reduces stress on the tagged animal. Tagging an animal multiple times increases stress. Re-tagging an animal after failure of a particular tag also increases animal stress. The tag of the invention reduces re-tagging and can virtually eliminate the need for multiple tags.

While the identification tag of this invention has been described with respect to a preferred embodiment, it shall be understood that various other changes and modifications may be made within the spirit and scope of the invention.

What is claimed is:

1. An animal identification tag comprising:
a panel;
a transponder casing attached to said panel, said casing having a transponder housed therein, said transponder capable of emitting a first identifier; and
a second identifier integral with said panel, said second identifier corresponding to said first identifier for identifying a particular animal.

2. A tag, as claimed in claim 1, further including:
a third identifier placed on said panel of said tag, said third identifier further corresponding to said first and second identifiers for identifying the particular animal.

3. A tag, as claimed in claim 2, further including:
a fourth identifier placed on said panel of said tag, said fourth identifier further corresponding to said first, second, and third identifiers for identifying the animal.

4. A tag, as claimed in claim 3, further including:
a fifth identifier placed on said panel of said tag, said fifth identifier further corresponding to said first, second, third, and fourth identifiers for identifying the animal.

5. A tag, as claimed in claim 1, wherein:
said second identifier is selected from the group consisting of a visual management number, a bar code number, a feed lot number, and an electronic identification number.

6. A tag, as claimed in claim 1, wherein:
said panel includes a neck portion, and a main body portion connected to said neck portion, said transponder casing being attached to said neck portion.

7. An animal identification system comprising:
a panel;
a transponder integral with said panel, said transponder emitting a first identifier for identification of an animal;
a second identifier placed on said panel, said second identifier corresponding to said first identifier for identification of the animal;
a database including a plurality of data fields and data entries for recording information about the animal, said database being organized according to said first and second identifiers to identify the animal, said database enabling a user to access information on the database to verify identification of the animal, and to manipulate information about the animal stored within the database.

8. A tag, as claimed in claim 7, wherein:
said second identifier is selected from the group consisting of a visual management number, a bar code number, a feed lot number, and an electronic identification number.

9. A system, as claimed in claim 7, wherein:
said panel includes a neck portion, and said transponder being attached to said neck portion.

10. A method of identifying an animal, said method comprising the steps of:
providing a transponder emitting a unique signal indicative of a first identifier, said transponder incorporated on a panel of an identification tag;
placing at least a second identifier on the panel of the identification tag;
matching the first and second identifiers;
recording the matched identifiers on a database;
distributing the tag and the database to users; and
installing the database in a computer including software for manipulating the database.

11. A method, as claimed in claim 10, further including the step of:
placing a third identifier on the panel of the ear tag, and creating another matching field within the database thus providing a third identifier for identifying the particular animal.

12. A tag, as claimed in claim 10, wherein:
said second identifier is selected from the group consisting of a visual management number, a bar code number, a feed lot number, and an electronic identification number.

13. A tag, as claimed in claim 10, wherein:
said panel includes a neck portion, and a main body portion connected to said neck portion, said transponder casing being attached to said neck portion.

14. An identification tag comprising:
a panel;
means attached to said panel for identifying an animal comprising a first identifier electronically emitted by the identifying means; and
a second identifier placed on said panel adjacent said identifying means, said second identifier being visually perceptible, and said second identifier matching said first identifier for redundant identification of the animal.

15. A tag, as claimed in claim 14, further including:
a third identifier placed on said tag and matching said first and second identifiers for identification of the animal.

16. A tag, as claimed in claim 14, further including:
a database for recording the first and second identifiers, said database containing information about the animal which is matched with said first and second identifiers.

17. A method of identifying an animal, said method comprising the steps of:
providing a plurality of identifiers incorporated on an identification tag;
matching the plurality of identifiers;
assigning the plurality of indicators to data fields within a database, said data fields corresponding to selected information about a particular tagged animal;
distributing the tag and the database to users; and
installing the database in a computer including software for manipulating the database to selectively edit and retrieve information about the animal.

18. A method, as claimed in claim 17, wherein:
said plurality of indicators are selected from the group consisting of an electronic identifier emitted by a transponder incorporated within the panel of the tag, a visual management number, a barcode number, a feed lot number, and an electronic identification number.

19. A method, as claimed in claim 17, wherein:
said panel includes a neck portion, and a main body portion connected to said neck portion, at least one of said identifiers being attached to said neck portion.
